(19) United States
(12) Patent Application Publication
(10) Pub. No.: US 2026/0254174 A1
(43) Pub. Date: Aug. 27, 2026

(54) ROTATABLE CONNECTOR POSITION ASSURANCE WITH SLIDABLE INTERLOCK FUNCTION

(71) Applicant: FCI USA LLC, Etters, PA (US)

(72) Inventor: Stephen Michael Koullias, Dover, PA (US)

(73) Assignee: FCI USA LLC, Etters, PA (US)

(21) Appl. No.: 19/651,266

(22) Filed: Apr. 17, 2026

Related U.S. Application Data
(60) Provisional application No. 63/890,098, filed on Sep. 29, 2025.

(51) Int. Cl. H01R 13/707; H01R 13/506; H01R 13/629; H01R 13/641

(52) U.S. Cl. CPC H01R 13/707; H01R 13/506; H01R 13/62938; H01R 13/6295; H01R 13/62955; H01R 13/641

(57) ABSTRACT

Electrical connector systems implementing HVIL by means of a CPA are provided to ensure reliable connection. Touch-safe and reliable connection is ensured through the use of an electrical connector including a rotating latch configured to rotate between a disengaged state and an engaged state and a CPA configured to slide between an unlocked position and a locked position.

### CROSS-REFERENCE TO RELATED APPLICATIONS

This application claims benefit under 35 U.S.C. § 119(e) of U.S. Provisional Application Ser. No. 63/890,098, filed Sep. 29, 2025, and titled “ROTATABLE CONNECTOR POSITION ASSURANCE WITH SLIDABLE INTERLOCK FUNCTION,” which is incorporated herein by reference in its entirety.

### BACKGROUND

Electrical connectors may facilitate transfer of electrical power. Electrical connectors may transfer electrical power at high voltages. In a high voltage interlock (HVIL) system, high voltages are not applied to terminals of an electrical connector unless an interlock circuit of the electrical connector is closed. A connector position assurance (CPA) is a mechanism which ensures that mated electrical connectors remain mated and/or that the mated state ensures electrical connection.

### SUMMARY

According to an aspect of the technology, an electrical connector is provided. The electrical connector comprises a first housing configured to mate with a second housing and a rotating latch configured to rotate about the first housing between a disengaged state and an engaged state, facilitate mating of the first housing and the second housing when the rotating latch transitions from the disengaged state to the engaged state, and prevent unmating of the first housing and the second housing when the rotating latch is in the engaged state. The rotating latch includes a connector position assurance (CPA) configured to slide between an unlocked position and a locked position. The CPA includes a conductive member configured to make electrical contact with sense leads when the CPA is in the locked position. The CPA prevents rotation of the rotating latch from the engaged state to the disengaged state when the CPA is in the locked position.

### BRIEF DESCRIPTION OF DRAWINGS

Various aspects and embodiments will be described with reference to the following figures. The figures are not necessarily drawn to scale.

FIG. 1 is a perspective view of an electrical connector system including a first electrical connector, a second electrical connector, and a rotating latch in a disengaged state, according to some embodiments.

FIG. 2 is a perspective view of the electrical connector system of FIG. 1 with the rotating latch transitioning between the disengaged state and an engaged state, according to some embodiments.

FIG. 3 is a perspective view of the electrical connector system of FIG. 1 with the rotating latch in the engaged state, according to some embodiments.

FIG. 4 is a cross-sectional perspective view of the electrical connector system of FIG. 1 with the rotating latch in the engaged state and a slidable member in an unlocked position, according to some embodiments.

FIG. 5 is a perspective view of the electrical connector system of FIG. 1 with the rotating latch in the engaged state and the slidable member in the unlocked position, according to some embodiments.

FIG. 6 is a perspective view of the electrical connector system of FIG. 1 with the rotating latch in the engaged state and the slidable member in a locked position, according to some embodiments.

FIG. 7 is a perspective view of an electrical receptacle with a rotating latch and having a first mating interface and being configured to be disposed at an end of a cable.

FIG. 8 is a perspective view of an electrical plug with a pin and having a second mating interface, having an 85 A carrying capacity, and being configured for mounting to a printed circuit board.

FIG. 9 is a perspective view of an exploded electrical plug with a rotating latch and having a third mating interface, having a 125 A carrying capacity, and being configured to be disposed at an end of a cable.

FIG. 10 is a perspective view of an exploded electrical receptacle with a pin and having a fourth mating interface, having a 250 A carrying capacity, and being configured for snap mount on a printed circuit board.

### DETAILED DESCRIPTION

Increasing power needs, for example in data centers and electric vehicles, has led to electrical connectors operating at high voltages. In many systems human operators may have a need to connect and disconnect such electrical connectors. The inventors have appreciated a need for safety features for electrical connectors operating at high voltages.

Implementing high voltage interlock loop (HVIL) technology allows electrical connectors with improved safety. Advantageously, electrical connectors implementing HVIL may be configured such that the interlock circuit is opened before the high-voltage terminals are exposed when unmating electrical connectors.

Additionally, electrical connectors may unintentionally become unmated, for example due to vibrations of a system in which the electrical connectors are disposed. In some instances, electrical connectors which visually appear to be mated may not be electrically connected to one another, complicating diagnosis of an open circuit. Thus, it may be desirable to provide electrical connectors which resist unintentional disconnection and for which a mated state ensures electrical connection.

A connector position assurance (CPA) may be able to be transitioned to a locked position only when a first electrical connector and a second electrical connector are fully mated. In the locked position, the CPA may prevent unmating of the electrical connectors. Advantageously, the CPA may be vibration-resistant to prevent unintentional disengagement. Further advantageously, unlocking the CPA may require a separate action than pulling apart the electrical connectors in a mating direction. Accordingly, electrical connectors having a locked CPA may resist unintentional unmating. Additionally, connectors having an engaged CPA may be visually confirmed to be fully mated.

The inventors have appreciated the foregoing and recognized that it may be advantageous to provide for electrical connector systems including interlock terminals which may be electrically connected only when a CPA is locked. Further, the inventors have appreciated that it may be advantageous to provide for interlock terminals which are electrically connected only when the CPA is locked in the locked position.

Additionally, the inventors have appreciated that, in some electrical connector systems in which it may be desirable to implement a CPA with interlock function, it may be advantageous to provide a rotating latch which transitions between disengaged and engaged states by rotation and a CPA which transitions between unlocked and locked positions by sliding.

Following below is further detailed description of embodiments applying concepts relating to electrical connectors implementing rotating latches with slidable interlock function. Aspects described herein may be implemented in numerous ways; examples of specific implementations are provided herein for illustrative purposes only.

Aspects of the technology described herein may be implemented in any suitable electrical connector system. For example, aspects of the technology described herein may be implemented in whip connectors, pin-and-socket connectors, rack-to-rack power systems, board-mount connectors, and/or snap-in panel mount connectors. The electrical connector system may have any suitable current carrying capacity, including up to 60 Amps, up to 85 Amps, up to 125 Amps, up to 250 Amps or greater.

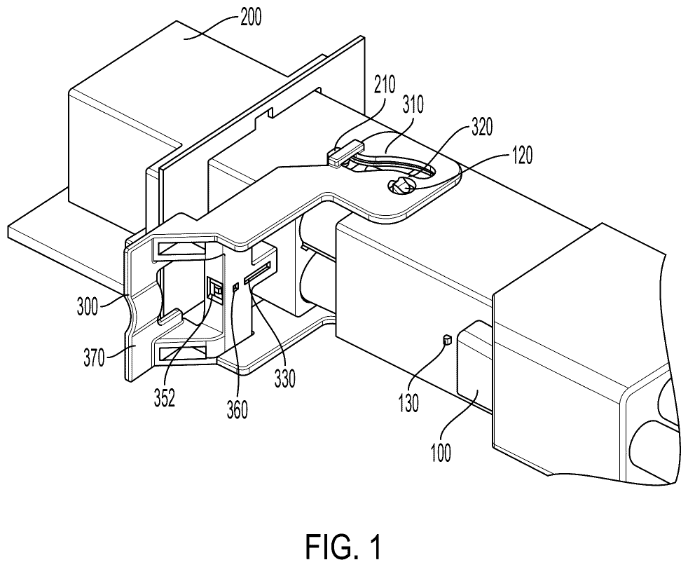

FIG. 1 is a perspective view of an electrical connector system including a first electrical connector 100, a second electrical connector 200, and a rotating latch 300 in a disengaged state.

For ease of understanding, an overview of functionality of the electrical connector system is first provided. Following this overview, components of the first electrical connector 100, the second electrical connector 200, and the rotating latch 300 are further described. Thereafter, engaging and disengaging processes of the rotating latch 300 and locking and unlocking processes of the CPA 350 are further described.

High-voltage electrical power may only flow between the first electrical connector 100 and the second electrical connector when an HVIL circuit is closed. The HVIL circuit may not be closed without first engaging the rotating latch 300, which engaging completes mating of high voltage terminals of the first electrical connector 100 and the second electrical connector 200. Further, closing the HVIL circuit requires locking the rotating latch 300 such that the rotating latch 300 may not be disengaged without the HVIL circuit being opened. Accordingly, an operator of the electrical connector system may safely mate and unmate the electrical connector system without exposure to high voltages within the first electrical connector 100 and the second electrical connector 200.

Having thus provided an overview of the functioning of the electrical connector system, components of the first electrical connector 100, the second electrical connector 200, and the rotating latch 300 will now be further described.

The first electrical connector 100 may include a protrusion 120, a bump 130, a cavity 150, and sense leads 152. In some embodiments, the first electrical connector 100 may be, or may include, a housing serving to secure, protect, and/or insulate conductive elements within the housing. For example, such conductive elements may be disposed in a plurality of terminals through which the first electrical connector 100 is configured to transmit electrical power and/or signals when mated to respective terminals of the second electrical connector 200.

The protrusion 120 may be configured to retain the rotating latch 300. For example, the protrusion 120 may engage with an opening 320 of the rotating latch. The first electrical connector 100 may include a first protrusion 120 on a first side of the first electrical connector 100 and a second protrusion 120 on a second side of the first electrical connector 100 opposite the first side. Accordingly, the first protrusion 120 and the second protrusion 120 may define an axis of rotation about which the rotating latch 300 is configured to rotate, for example when transitioning between the disengaged state and the engaged state.

The bump 130 may be configured to permit a component of the rotating latch 300 to transition from an unlocked position to a locked position. For example, when the rotating latch 300 is in the engaged state, the bump 130 may be disposed in an opening 330 of the rotating latch 300. Disposing the bump 130 in the opening 330 may cause the bump 130 to engage with a latch 354 of a CPA 350 of the rotating latch 300. Engagement of the bump 130 with the latch 354 may cause the latch 354 to deflect out of the opening 330, thus allowing the CPA 350 to transition to a locked position, as further described herein.

The cavity 150 may be configured to receive the CPA 350 when the CPA 350 is in the locked position. In some embodiments, the sense leads 152 may be disposed within the cavity 150; the conductive member 352 may make electrical contact with the sense leads 152 when the cavity 150 receives the CPA 350. In some embodiments, a wall of the cavity 150 may be configured to engage with the CPA 350 when the CPA 350 is in the locked position such that the CPA 350 prevents the rotating latch 300 from transitioning from the engaged position to the disengaged position.

The second electrical connector 200 may include a pin 210. In some embodiments, the second electrical connector 200 may be, or may include, a housing serving to secure, protect, and/or insulate conductive elements within the housing. For example, such conductive elements may be disposed in a plurality of terminals through which the second electrical connector 200 is configured to transmit electrical power and/or signals when mated to respective terminals of the first electrical connector 100.

The pin 210 may be configured to engage with a component of the rotating latch 300 to facilitate mating of the second electrical connector 200 to the first electrical connector 100. For example, the pin 210 may be configured to engage with a slot 310 of the rotating latch 300. Engagement of the pin 210 with the slot 310 may be configured to facilitate mating of the second electrical connector 200 and the first electrical connector 100, as further described herein. In some embodiments, the pin 210 may be configured to travel within the slot 310 when the rotating latch 300 transitions from the disengaged state to the engaged state. In the engaged state, the pin 210 may be disposed at a closed end of the slot 310. The second electrical connector 200 may include a first pin 210 on a first side of the second electrical connector 200 and a second pin 210 on a second side of the second electrical connector 200.

The rotating latch 300 may include the slot 310, the opening 320, the opening 330, a CPA 350 having a conductive member 352 and the latch 354, the notch 360 and a lever 370. The rotating latch 300 may include any suitable material. For example, the rotating latch 300 may include electrically insulative material.

The slot 310 may be configured to facilitate mating of the first electrical connector 100 and the second electrical connector 200. For example, the pin 210 may engage with the slot 310 when the first electrical connector 100 is mated to the second electrical connector 200. The pin 210 may travel within the slot 310 when the rotating latch 300 transitions between the disengaged state and the engaged state. Engagement between the pin 210 and the slot 310 may physically draw the first electrical connector 100 and the second electrical connector 200 together along the mating direction when the rotating latch 300 transitions to the engaged state (e.g., when the lever 370 is rotated toward connector 100). Engagement between the pin 210 and the slot 310 may physically separate the first electrical connector 100 from the second electrical connector 200 when the CPA transitions to the disengaged state.

In some embodiments, the rotating latch 300 may be shaped such that the first electrical connector 100 and the second electrical connector 200 may not be mated without a component of the second electrical connector 200 engaging with the slot 310. For example, if the rotating latch 300 is in the engaged state on the first electrical connector 100 when an operator attempts to mate the second electrical connector 200 to the first electrical connector 100, the rotating latch 300 may block movement of the pin 210 in the mating direction, thus preventing mating between the first electrical connector 100 and the second electrical connector 200. Contrastingly, when the rotating latch 300 is in the disengaged state, the slot 310 of the rotating latch 300 may receive the pin 210 in the mating direction, allowing mating between the first electrical connector 100 and the second electrical connector 200.

The opening 320 may be configured to engage with a component of the first electrical connector. For example, the opening 320 may engage with the protrusion 120 of the first electrical connector 100. Engagement between the opening 320 and the protrusion 120 may secure the rotating latch 300 to the first electrical connector 100.

The opening 330 may be configured to receive a component of the CPA 350 when the CPA 350 is in the unlocked position. For example, the latch 354 of the sliding member may be disposed in the opening 330 when the CPA 350 is in the unlocked position. An edge of the opening 330 may engage with the latch 354 to prevent the CPA 350 from transitioning to the locked position when the rotating latch 300 is in the disengaged state. When the rotating latch 300 is in the engaged state, the opening 330 may receive the bump 130. Receiving the bump 130 may displace the latch 354 such that the edge of the opening does not engage with the latch 354 to prevent the CPA 350 from transitioning to the locked position.

The CPA 350 may be disposed on the rotating latch 300. In some embodiments, the CPA 350 may be retained in one or more slots of the rotating latch 300. The CPA 350, when in the locked position, may function to retain the rotating latch 300 in the engaged state. In some embodiments, the CPA 350 may transition between the unlocked position and the locked position by sliding in the mating direction.

The conductive member 352 may be disposed on the CPA 350. The conductive member 352 may be configured to establish an electrical connection between the sense leads 152 when the CPA 350 is in the locked position. The conductive member 352 may include any suitable electrically conductive material. In some embodiments, the conductive member 352 may have a predetermined electrical resistance to facilitate operation of an HVIL system of which the sense leads 152 are a component.

The notch 360 may be configured to receive a component of the CPA 350 when the CPA 350 is in the locked position. For example, the notch 360 may be configured to receive the latch 354 when the CPA 350 is in the locked position. The latch 354 may be shaped to allow sliding of the CPA 350 from the locked position to the unlocked position when a force is applied to the CPA 350 in the mating direction (e.g., towards a mating interface of the first electrical connector 100).

The lever 370 may be a component of the rotating latch 300 configured to allow an operator to conveniently rotate the rotating latch 300. In some embodiments, the lever 370 may extend perpendicular to the mating direction when the rotating latch 300 is in the disengaged state and parallel to the mating direction when the rotating latch 300 is in the engaged state.

Having thus provided description of components of the first electrical connector 100, the second electrical connector 200, and the rotating latch 300, engaging and disengaging processes of the rotating latch 300 and locking and unlocking processes of the CPA 350 will now be further described.

As noted, FIG. 1 is a perspective view of the electrical connector system with the rotating latch 300 in the disengaged state.

The electrical connector system may transition to the disengaged state from an unassembled state by coupling the rotating latch 300 to the first electrical connector 100. For example, electrical connector system may transition to the disengaged state from the unassembled state by engaging the protrusion 120 with the opening 320.

In the disengaged state, the first electrical connector 100 may not be fully mated to the second electrical connector 200. For example, electrically conductive terminals of the first electrical connector 100 may not be in electrical contact with electrically conductive terminals of the second electrical connector 200.

In the disengaged state, the lever 370 may extend perpendicular to the mating direction of the electrical connector system.

In the disengaged state, the rotating latch 300 may be oriented to receive a component of the second electrical connector 200. For example, an opening of the slot 310 may be facing the mating direction to receive the pin 210.

In the disengaged state, the CPA 350 may be in the unlocked position. For example, the latch 354 may engage with the edge of the opening 330 to prevent the CPA 350 from transitioning to the locked position. In some embodiments, the latch 354 may interfere with sliding of the CPA 350 from the unlocked position to the locked position. For example, the latch 354 may prevent sliding of the CPA 350.

The electrical connector system may transition from the disengaged position to the unassembled position by decoupling the rotating latch 300 from the first electrical connector 100, for example by disengaging the protrusion 120 from the opening 320.

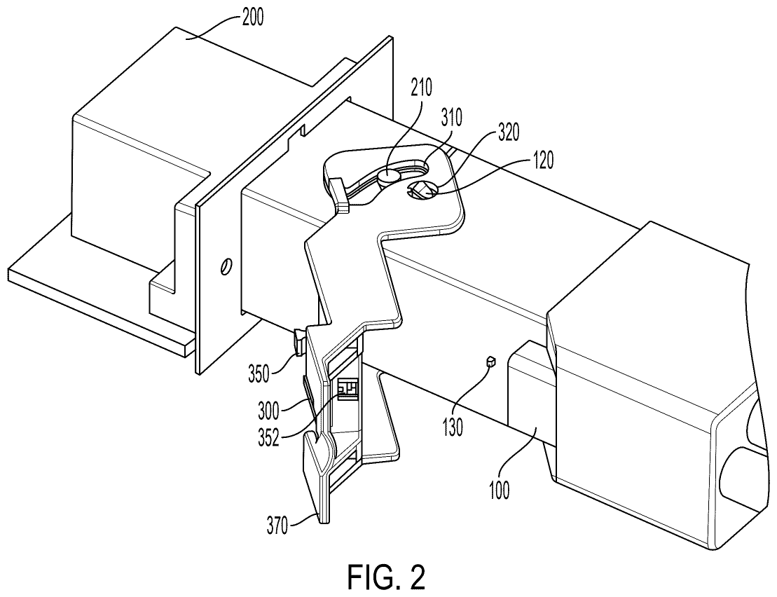

FIG. 2 is a perspective view of the electrical connector system with the rotating latch 300 transitioning between the disengaged state and the engaged state.

The rotating latch 300 may transition between the disengaged state and the engaged state (n.b. when the CPA 350 is in the unlocked position) responsive to force applied to the lever 370. For example, force applied to the lever 370 may cause the rotating latch 300 to rotate about the protrusion 120 due to engagement between the protrusion 120 and the opening 320.

When transitioning from the disengaged state to the engaged state, engagement between the pin 210 and the slot 310 as the pin 210 travels within the slot 310 may physically draw the first electrical connector 100 and the second electrical connector 200 together along the mating direction. Accordingly, transitioning from the disengaged state to the engaged state may facilitate mating of the first electrical connector 100 and the second electrical connector 200. In some embodiments, the first electrical connector 100 and the second electrical connector 200 may be unable to mate without the rotating latch 300 transitioning from the disengaged state to the engaged state.

When transitioning from the engaged state to the disengaged state, engagement between the pin 210 and the slot 310 as the pin 210 travels within the slot 310 may physically separate the first electrical connector 100 from the second electrical connector 200 in the mating direction. Accordingly, transitioning from the engaged state to the disengaged state may facilitate unmating of the first electrical connector 100 from the second electrical connector 200. In some embodiments, the first electrical connector 100 and the second electrical connector 200 may be unable to unmate without the rotating latch 300 transitioning from the engaged state to the disengaged state.

When transitioning between the engaged state and the disengaged state, the CPA 350 may be in the unlocked position.

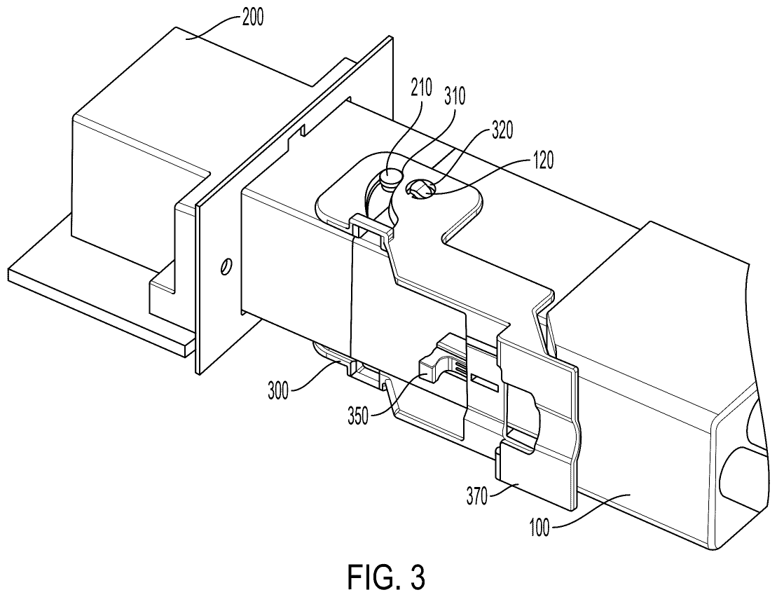

FIG. 3 is a perspective view of the electrical connector system with the rotating latch 300 in the engaged state.

The rotating latch 300 may transition to the engaged state by rotating until components of the electrical connector system mechanically prevent further rotation. For example, the pin 210 may travel through the slot 310 and, when entering the engaged state, arrive at a closed end which prevents further travel. Thus, in the engaged state, the pin 210 may be engaged with the closed end of the slot 310. As another example, the lever 370 may, when entering the engaged state, abut the first electrical connector 100. Thus, in the engaged state, the lever 370 may abut the first electrical connector 100.

In the engaged state, the pin 210 may engage with the rotating latch 300 to prevent relative motion of the first electrical connector 100 and the second electrical connector 200 away from one another in the mating direction.

In the engaged state, the opening 330 may receive the bump 130 such as may cause the latch 354 of the CPA 350 to deflect out of the opening 330. Thus, in the engaged state, the CPA 350 may be capable of transitioning from the unlocked position to the locked position. In some embodiments, the CPA 350 may be termed to be in a transition state when the rotating latch 300 is in the engaged state. For example, the slidable state may indicate the unlocked position wherein the CPA 350 may transition to the locked position responsive to a force applied to the CPA 350.

The rotating latch 300 may transition from the engaged state to the disengaged state by lifting the lever 370 away from the first electrical connector 100.

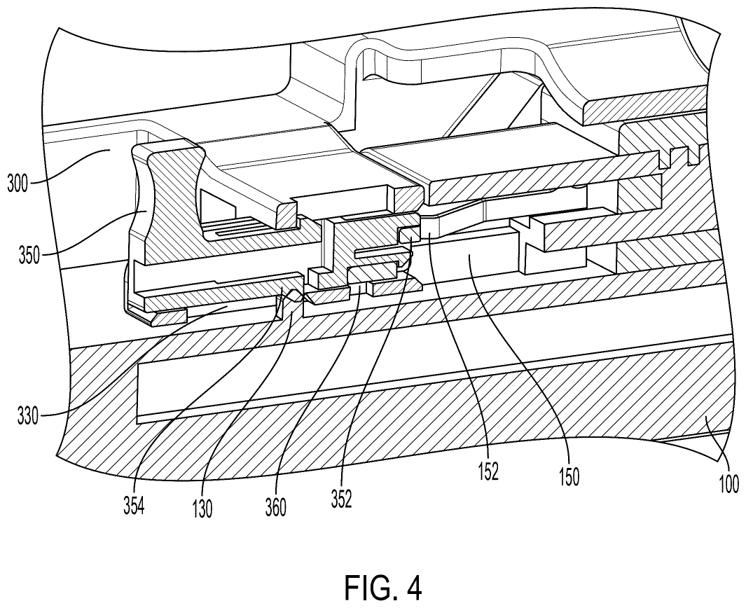

FIG. 4 is a cross-sectional perspective view of the electrical connector system with the rotating latch 300 in the engaged state and a CPA 350 in an unlocked position.

In FIG. 4, the latch 354 is not shown deflected by the bump 130. Rather, a portion of the latch 354 and a portion of the bump 130 are shown as occupying the same space within the opening 330. This representation of occupation of the same space illustrates why the latch 354 is deflected when the rotating latch 300 is in the engaged state and does not suggest that the latch 354 and the bump 130 in fact occupy the same space at the same time.

In the unlocked position, the conductive member 352 may not make electrical contact with the sense leads 152.

In the unlocked position, the CPA 350 may not prevent the rotating latch 300 from transitioning from the engaged state to the disengaged state. For example, the CPA 350 may not be disposed in the cavity 150.

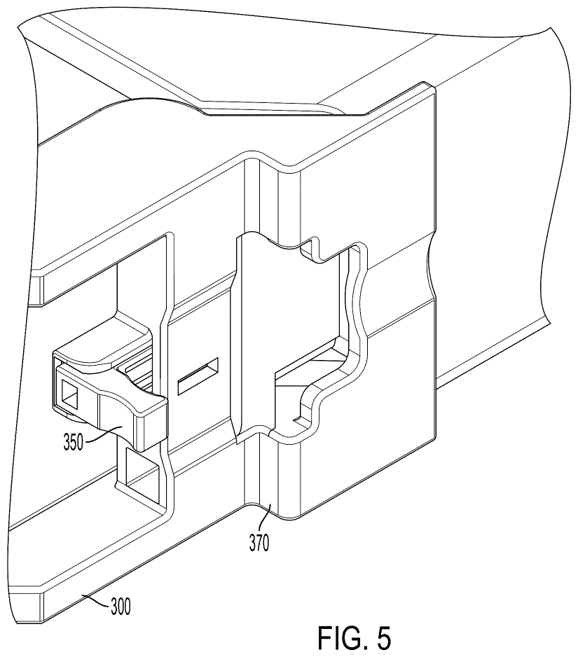

FIG. 5 is a perspective view of the electrical connector system with the rotating latch 300 in the engaged state and the CPA 350 in the unlocked position.

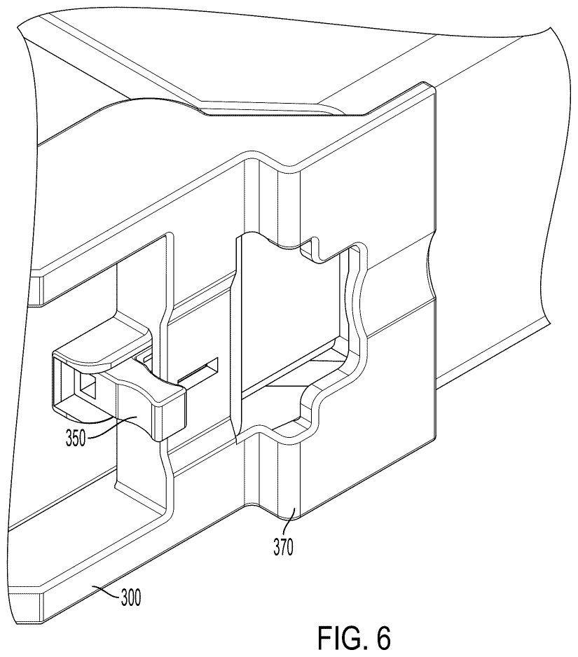

FIG. 6 is a perspective view of the electrical connector system with the rotating latch 300 in the engaged state and the CPA 350 in a locked position.

The CPA 350 may transition from the unlocked position to the locked position by a force applied to the CPA 350 in the mating direction. For example, the CPA 350 may slide relative to the rotating latch 300. In some embodiments, the CPA 350 may include a protrusion configured to slide within a slot of the rotating latch 300.

In the locked position, the conductive member 352 may make electrical contact with the sense leads 152.

In the locked position, the CPA 350 may prevent the rotating latch 300 from transitioning from the engaged state to the disengaged state. For example, the CPA 350 be disposed in the cavity 150 such that the CPA 350 engages with a wall of the cavity 150 to prevent rotation of the rotating latch 300.

In the locked position, the latch 354 may be received by the notch 360. When the CPA 350 arrives in the locked position, engagement of the latch 354 with the notch 360 may emit an audible click. The audible click may serve to indicate to an operator that the locked position has been entered. Engagement of the latch 354 with the notch 360 may prevent unintentional transitioning from the locked position to the unlocked position, for example as a result of vibration of the electrical connector system.

The CPA 350 may transition from the locked position to the unlocked position by applying a force to the CPA 350 in the mating direction (e.g., towards a mating interface of the first electrical connector 100). The latch 354 may be shaped such that this force allows removal of the latch 354 from the notch 360.

Aspects of the technology disclosed herein may be applied in electrical connectors having a variety of mating interfaces, current carrying capacities, and/or mounting applications.

For example, aspects of the technology disclosed herein may be applied in electrical connectors having any suitable mating interface. In some embodiments, different mating interfaces may have a different number of terminals (e.g., power terminals and/or signal terminals) than one another. In some embodiments, different mating interfaces may have different terminal arrangements (e.g., positioning of power terminals and/or signal terminals) than one another. A mating interface may be a plug interface or a receptacle interface. A receptacle interface may have socket terminals configured to receive pin terminals of a plug interface.

As another example, aspects of the technology disclosed herein may be applied in electrical connectors having any suitable current carrying capacity. Current carrying capacity may be a maximum current transmittable through the electrical connection without exceeding a predetermined temperature rise, for example 30° C., per power terminal of the electrical connector. Current carrying capacity may be determined at least in part by dimensions, such as pin diameter, of conductive elements within electrical connectors. For example, a greater pin diameter may correspond to a greater current carrying capacity. In some embodiments, electrical connectors implementing technology as disclosed herein may have a current carrying capacity of between 30 A and 300 A. In some embodiments, electrical connectors implementing technology as disclosed herein may have a current carrying capacity of 60 A, 85 A, 125 A, or 250 A. In some embodiments, a particular mating interface of an electrical connector may correspond to, and/or be based on, a particular current carrying capacity of the electrical connector.

As a further example, aspects of the technology disclosed herein may be applied in electrical connectors having any suitable mounting configuration. In some embodiments, electrical connectors implementing technology as disclosed herein may be configured for snap mount, wherein the electrical connector may fit into, and/or engage with edges of, a cutout of a printed circuit board, for example such that a mating interface of the electrical connector faces orthogonal to a surface of the printed circuit board. In some embodiments, electrical connectors implementing technology as disclosed herein may be configured for mounting to a printed circuit board, wherein the electrical connector coupled to a surface of the printed circuit board, for example such that a mating interface of the electrical connector faces parallel to the surface of the printed circuit board. In some embodiments, electrical connectors implementing technology as disclosed herein may be disposed at an end of a cable. For clarity, electrical connectors configured in different mounting configurations may be configured to mate with one another. For example, a first electrical connector disposed at the end of a cable may be configured to mate with a second electrical connector configured for snap mount and/or a third electrical connector configured for mounting to a printed circuit board.

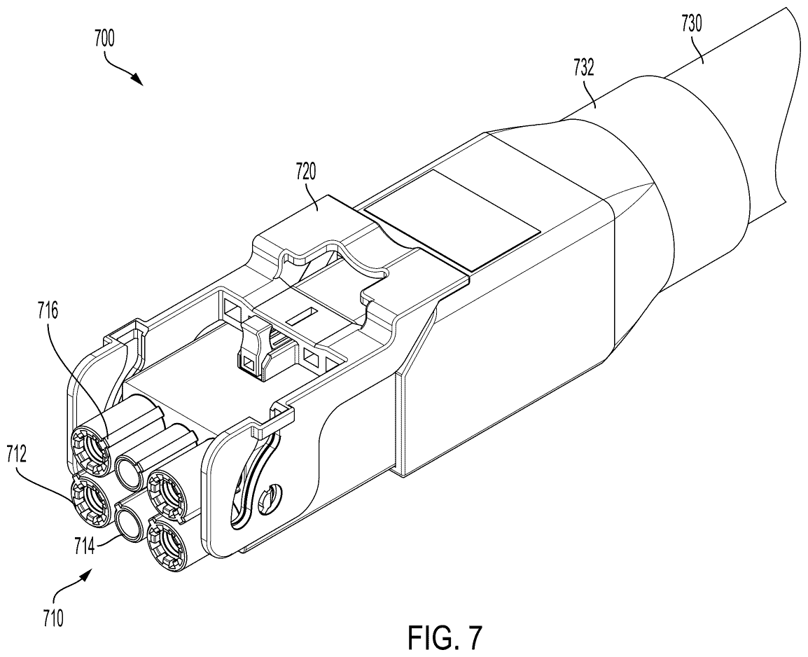

FIGS. 7-10 illustrate non-limiting examples of electrical connectors in which aspects of the technology disclosed herein may be implemented and which have a variety of mating interfaces, current carrying capacities, and mounting applications.

FIG. 7 is a perspective view of an electrical receptacle 700 with a CPA 720 and having a first mating interface 710, having a 60 A carrying capacity, and being configured to be disposed at an end of a cable bundle 730.

The mating interface 710 may be configured to mate with a complementary mating interface. A complementary mating interface may have a matching arrangement of power terminals 712 and/or signal terminals 714. A complementary mating interface to a socket interface may be a plug interface, and a complementary mating interface to a plug interface may be a socket interface.

The mating interface 710 may include a plurality of power terminals 712 and/or signal terminals 714. As shown, the mating interface 710 includes four power terminals 712 and two signal terminals 714. In some embodiments, the four power terminals 712 may include: a power pin, a return pin, a common pin, and/or a protective earth pin. The signal terminals 714 may transmit, at any suitable frequency, any suitable electrical signals of an electrical system in which the electrical receptacle 700 is integrated.

The mating interface 710 may include one or more coding projections 716 configured to prevent improper—for example, reversed polarity—mating of an electrical connector. The coding projections 716 may be, as shown, disposed on the power terminals 712 and/or the signal terminals 714. The coding projections 716 may be configured to be received by corresponding coding spaces a mating electrical connector.

The mating interface 710 may include any suitable arrangement of the power terminals 712 and/or the signal terminals 714. The shown mating interface 710 includes an arrangement as follows: a first row of a power terminal 712, a signal terminal 714, and a second power terminal 712; and a second row of a power terminal 712, a signal terminal 714, and a second power terminal 712. As another non-limiting example, the shown arrangement may also be described as follows: a first column of two power terminals 712; a second column of two signal terminals 714; and a third column of two power terminals 712. In the shown arrangement, a center of a signal terminal 714 is aligned with centers of the adjacent power terminals 712, for example such that the center of the signal terminal 714 lies along a line between the centers of the adjacent power terminals 712.

The CPA 720 may have components and/or characteristics of the rotating latch 300 described herein.

The cable bundle 730 may include a plurality of conductive elements electrically connected to respective power terminals 712 and/or signal terminals 714 of the mating interface 710. Conductive elements of the cable bundle 730 may have dimensions corresponding to dimensions of the respective power terminals 712 and/or the signal terminals 714. Conductive elements of the cable bundle 730 may be surrounded with one or more electrically insulative coatings. In some embodiments, the cable bundle 730 may include a Type W cable. In some embodiments, the cable bundle 730 may include a Type SOOW cable.

A proximate end of the cable bundle 730 may be coupled to the electrical receptacle 700 via a cable overmold 732. The cable overmold 732 may be, for example, an electrically insulative material formed around the cable bundle 730 to retain components of the cable bundle 730 together and/or to retain the cable bundle 730 to the electrical receptacle 700. A distal end (not shown) of the cable bundle 730 may be electrically connected to any suitable component of an electrical system of which the electrical receptacle 700 is a part.

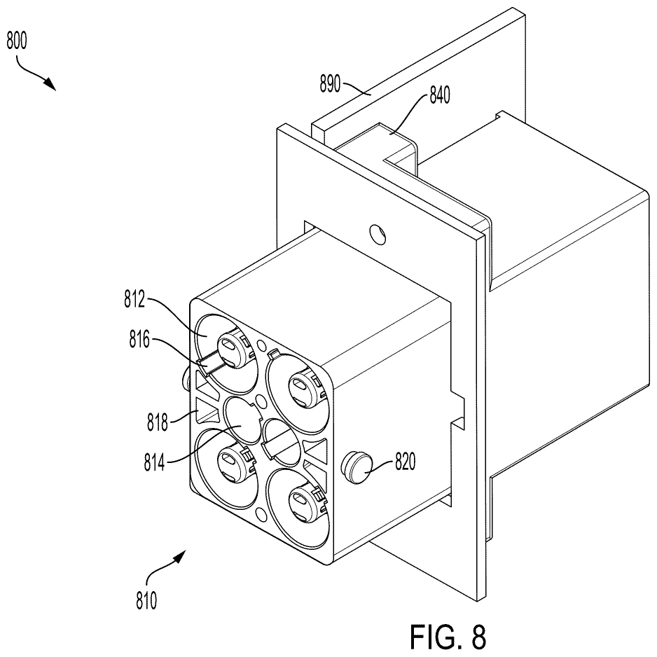

FIG. 8 is a perspective view of an electrical plug 800 with a pin 820 and having a second mating interface 810, having an 85 A carrying capacity, and being configured for mounting to a printed circuit board 890.

As shown, the mating interface 810 may include one or more coding spaces 816. The coding spaces 816 may be complementary to coding protrusions of a mating connector.

As shown, the mating interface 810 may include one or more gaps 818. In some embodiments, the gaps 818 may remain empty (e.g., filled with air) when the electrical plug 800 is mated to a complementary mating connector to improve signal integrity of signals transmitted on the signal terminals 814. For example, the gaps 818 remaining empty may reduce the relative permittivity of the electrical plug 800.

The shown mating interface 810 includes an arrangement which may be non-limitingly described as follows: a power terminal 812 at each corner of the mating interface 810; and two signal terminals 814 disposed at the center of the mating interface 810. In the shown arrangement, the center of a signal terminal 814 does not lie along a line between centers of two power terminals 814 disposed at neighboring corners to each other. In the shown arrangement, the gaps 818 are disposed between each signal terminal 814 and a proximate edge of the mating interface 810.

As shown, the electrical plug 800 may be configured to be mounted on the printed circuit board 890. For example, the electrical plug 800 may include a protrusion 840 configured to couple the electrical plug 800 to the printed circuit board 890. In some embodiments, the protrusion 840 may include a threaded cavity configured to receive a screw retaining the electrical plug 800 to the printed circuit board.

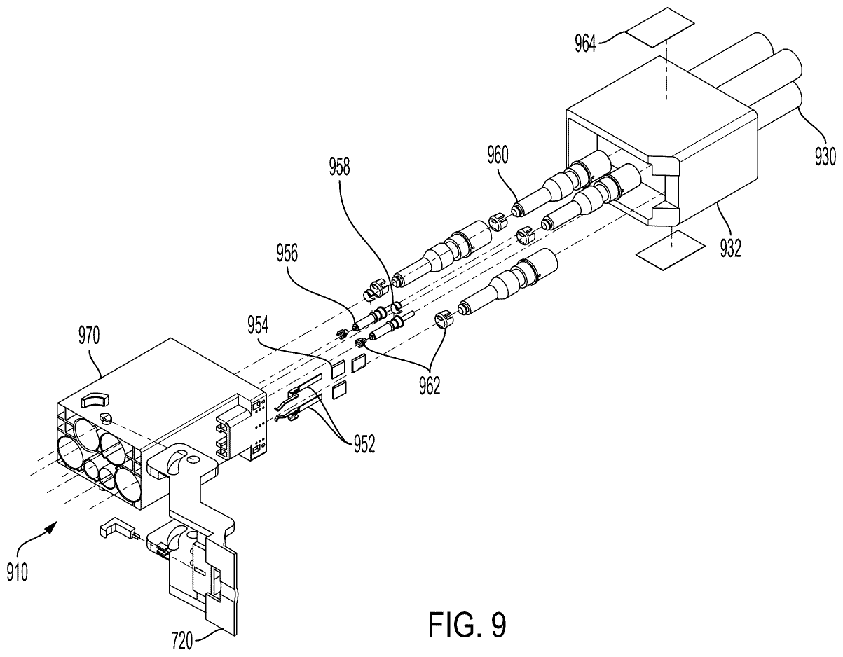

FIG. 9 is a perspective view of an exploded electrical plug 900 with a CPA 920 and having a third mating interface 910, having a 125 A carrying capacity, and being configured to be disposed at an end of a cable bundle 930.

The shown mating interface 910 includes an arrangement which may be non-limitingly described as follows: a first power terminal disposed in a first corner of the mating interface, the mating interface being rectangular; a second power terminal disposed in a second corner of the mating interface, the second corner sharing a first long side with the first corner; a first gap disposed in a third corner; a second gap disposed in a fourth corner, the fourth corner sharing a long second side with the third corner; a third power terminal and a fourth power terminal disposed at the second long side between the first gap and the second gap; and a first signal terminal and a second terminal disposed at the first long side between the first power terminal and the second power terminal.

The exploded view in FIG. 9 provides a clear view of certain components of the electrical plug 900 which may, as described herein, also be found in other electrical connectors described herein.

Housing 970 may be an insulative structure of the electrical plug 900.

Sense leads 952 may have the characteristics of the sense leads 152 described herein.

Overmold dams 954 may be configured to create a seal and/or boundary when overmolding the cable bundle 930.

Signal pins 956 may be a conductive elements of signal terminals.

Signal retention clips 958 may be configured to retain the signal pin 956 within the signal terminals.

Power pins 960 may be a conductive element of power terminals.

Pin caps 962 may be configured to render the signal pins 956 and/or the power pins 960 touch-proof. As shown, the pin caps 962 may include pin caps 962 of a first size corresponding to the signal pins 956 and/or pin caps 962 of a second size corresponding to the power pins 960.

Cable bundle 930 may have components and/or characteristics of the cable bundle 730.

Overmold 932 may have components and/or characteristics of the overmold 732.

Stickers 964 may display information about the electrical plug 900.

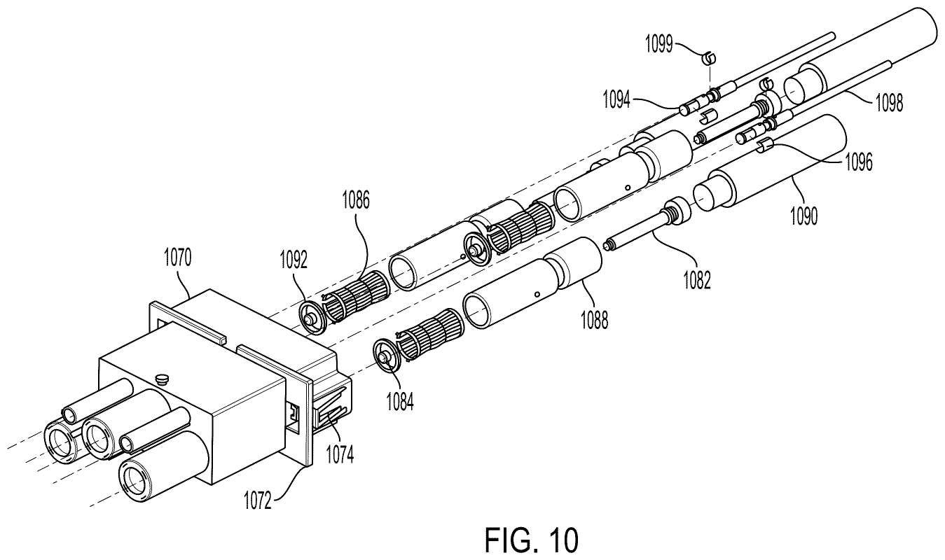

FIG. 10 is a perspective view of an exploded electrical receptacle 1000 with a pin and having a fourth mating interface, having a 250 A carrying capacity, and being configured for snap mount on a printed circuit board.

The shown mating interface 1010 includes an arrangement which may be non-limitingly described as follows: a first power terminal disposed in a first corner of the mating interface, the mating interface being rectangular; a second power terminal disposed in a second corner of the mating interface, the second corner sharing a long first side with the first corner; a third power terminal disposed at a long second side and between the first power terminal and the second power terminal; and a first signal terminal and a second signal terminal disposed at the long second side and at either side of the third power terminal.

The exploded view in FIG. 10 provides a clear view of certain components of the electrical receptacle 1000 which may, as described herein, also be found in other electrical connectors described herein.

Housing 1070 may be an insulative structure of the electrical receptacle 1000. The housing 1070 as shown is configured for snap mount on a printed circuit board. For example, the housing 1070 includes a flange 1072 and a clip 1074. When the housing 1070 is mounted on a printed circuit board, the flange 1072 may be disposed on and/or parallel to the printed circuit board. When the housing 1070 is mounted to a printed circuit board, the clip 1074 may engage with an edge of the printed circuit board to retain the housing 1070 to the printed circuit board. The clip 1074 may have, for example, a slot configured to receive an edge of a printed circuit board and a slant configured to guide the edge to the slot and prevent removal of the edge from the slot.

Post 1082 may be configured to, along with the post cap 1084, render the power socket and/or the signal sockets touch-proof.

Socket holder 1086 and/or socket band power connector 1088 may be electrically connected to power cables 1090, may be configured to receive pins of a mating electrical connector, and may be retained in the housing 1070 via socket band retention cap 1092.

Socket retention cap 1092 may be configured to retain a socket in the housing 1070.

Signal contact holder 1094 and/or signal contact band 1096 may be electrically connected to signal cables 1098 and may be retained in the housing 1070 via signal retention clip 1099.

Having thus described several aspects of at least one embodiment, various alterations, modifications, and improvements will readily occur to those skilled in the art. For example, an electrical connector system may be provided in which various apertures, slots, cavities, openings, and notches have different shapes than shown herein. Additionally, while a protrusion of a first electrical connector is described herein as engaging with an opening of a CPA to retain the CPA, in some embodiments a protrusion of the CPA may engage with an opening of the first electrical connector to retain the CPA. Further, other complementary mating features may be used in addition to or in place of the latches, protrusions, slots, openings, bumps, and notches described herein. As a yet further example, though a lever of the CPA is described herein as extending perpendicular to the first electrical connector when the CPA is in a disengaged state, a CPA may be provided with levers which extend at other angles suitable for the functionality described herein. Such alterations, modifications, and improvements are intended to be part of this disclosure and within the spirit and scope of the principles described herein. Accordingly, the foregoing description and drawings are by way of example only.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Use of ordinal terms such as “first,” “second,” “third,” et cetera, does not by itself connote any priority, precedence, or order of one element over another or the temporal order in which acts of a method are performed. Such terms are used merely as labels to distinguish one element having a certain name from another element having a same name (but for use of the ordinal term) to distinguish the elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. An electrical connector, comprising:
a first housing configured to mate with a second housing; and
a rotating latch configured to:
rotate about the first housing between a disengaged state and an engaged state;
facilitate mating of the first housing and the second housing when the rotating latch transitions from the disengaged state to the engaged state; and
prevent unmating of the first housing and the second housing when the rotating latch is in the engaged state,
wherein the rotating latch includes:
a connector position assurance (CPA) configured to slide between an unlocked position and a locked position, the CPA including a conductive member configured to make electrical contact with sense leads when the CPA is in the locked position, and
wherein the CPA prevents rotation of the rotating latch from the engaged state to the disengaged state when the CPA is in the locked position.

2. The electrical connector of claim 1, wherein the rotating latch interferes with sliding of the CPA from the unlocked position to the locked position when the rotating latch is in the disengaged state.

3. The electrical connector of claim 2, wherein the rotating latch further includes an opening configured to receive a bump of the first housing when the rotating latch is in the engaged state.

4. The electrical connector of claim 3, wherein the CPA includes a latch configured to be disposed in the opening when the rotating latch is in the disengaged state.

5. The electrical connector of claim 4, wherein the latch is configured to be disposed in a notch of the rotating latch when the CPA is in the locked position.

6. The electrical connector of claim 1, wherein the rotating latch includes a slot configured to receive a portion of the second housing in a mating direction when the rotating latch is in the disengaged state.

7. The electrical connector of claim 1, wherein:
the rotating latch further includes a lever; and
the CPA is disposed on the lever.

8. The electrical connector of claim 1, wherein the first housing comprises a mating interface comprising:
one or more power terminals; and
one or more signal terminals.

9. The electrical connector of claim 8, wherein the one or more power terminals and the one or more signal terminals are arranged in:
a first row having a first power terminal, a first signal terminal, then a second power terminal in order along the first row; and
a second row having a third power terminal, a second signal terminal, then a fourth power terminal in order along the second row.

10. (canceled)

11. The electrical connector of claim 8, wherein the one or more power terminals and the one or more signal terminals are arranged with:
four power terminals disposed at respective corners of the mating interface such that lines connecting adjacent ones of the four power terminals rectangularly bound a center region of the mating interface; and
two signal terminals disposed at the center region of the mating interface.

12. (canceled)

13. The electrical connector of claim 8, wherein the one or more power terminals and the one or more signal terminals are arranged with:
a first power terminal disposed in a first corner of the mating interface;
a second power terminal disposed in a second corner of the mating interface, the second corner sharing a first side with the first corner;
a third power terminal and a fourth power terminal disposed at a second side opposite the first side; and
a first signal terminal and a second signal terminal disposed at the first side between the first power terminal and the second power terminal.

14. (canceled)

15. The electrical connector of claim 8, wherein the one or more power terminals and the one or more signal terminals are arranged with:
a first power terminal disposed in a first corner of the mating interface;
a second power terminal disposed in a second corner of the mating interface, the second corner sharing a first side with the first corner;
a third power terminal disposed at a second side opposite the first side; and
a first signal terminal and a second signal terminal disposed at the second side on respective sides of the third power terminal.

16. (canceled)

17. (canceled)

18. (canceled)

19. The electrical connector of claim 8, wherein:
one of the first housing and the second housing is configured to be disposed at an end of a cable bundle; and
one of the first housing and the second housing is configured for mounting to a printed circuit board.

20. The electrical connector of claim 8, wherein the one of the first housing and the second housing which is configured for mounting to a printed circuit board is configured for snap mounting to the printed circuit board.

21. (canceled)

22. An electrical connector, comprising:
a first housing; and
a rotating latch rotatably coupled to the first housing and comprising a CPA, wherein:
the CPA comprises a conductive member;
the first housing comprises a cavity configured to receive a component of the CPA; and
the electrical connector further comprises sense leads exposed in the cavity and configured to be electrically connected to the conductive member of the CPA.

23. The electrical connector of claim 22, wherein the first housing further comprises a bump configured to interfere with a portion of the CPA to allow the CPA to be received by the cavity.

24. The electrical connector of claim 23, wherein:
the first housing comprises a protrusion;
the rotating latch comprises an opening; and
the protrusion engages with the opening to couple the rotating latch to the first housing.

25. (canceled)

26. (canceled)

27. An electrical connector system, comprising:
a first housing, comprising:
a first mating interface;
a first housing complementary mating feature;
a second housing configured to mate with the first housing, the second housing comprising:
a second mating interface complementary to the first mating interface;
a second housing complementary mating feature; and
a rotating latch configured to couple to the first housing, the rotating latch comprising:
a first rotating latch complementary mating feature configured to engage with the first housing complementary mating feature to retain the rotating latch to the first housing and allow the rotating latch to rotate between a disengaged state and an engaged state;
a second rotating latch complementary mating feature configured to engage with the second housing complementary mating feature to prevent unmating of the first housing and the second housing when the rotating latch is in the engaged state; and
a connector position assurance (CPA) configured to slide between an unlocked position and a locked position, the CPA comprising a conductive member configured to make electrical contact with sense leads of the electrical connector system when the CPA is in the locked position.

28. The electrical connector system of claim 27, wherein the CPA prevents rotation of the rotating latch from the engaged state to the disengaged state when the CPA is in the locked position.

29. The electrical connector system of claim 28, wherein the rotating latch prevents sliding of the CPA from the unlocked position to the locked position when the rotating latch is in the disengaged state.

30. (canceled)
